(19) United States
(12) Patent Application Publication
(10) Pub. No.: US 2025/0393084 A1
(43) Pub. Date: Dec. 25, 2025

(54) MOBILE-WIRELESS LAN INTEGRATED SYSTEM SUPPORTING NETWORK SLICE SERVICE AND SERVICE METHOD THEREOF

(71) Applicant: NETCUBE INC, Seoul (KR)

(72) Inventor: Dong Ho YU, Seoul (KR)

(21) Appl. No.: 19/313,654

(22) Filed: Aug. 28, 2025

Related U.S. Application Data
(63) Continuation of application No. PCT/KR2024/002569, filed on Feb. 28, 2024.

(30) Foreign Application Priority Data
Feb. 28, 2023 (KR) 10-2023-0027319

(51) Int. Cl. H04W 76/12; H04W 12/06; H04W 84/12

(52) U.S. Cl. CPC H04W 76/12; H04W 12/06; H04W 84/12

(57) ABSTRACT

According to an embodiment of the present invention, a mobile-wireless local area network (LAN) integrated system includes: an IMW-AP function (Integrated Mobile WLAN AP function) configured to perform wireless LAN-based access with a user terminal and to deliver an internet protocol security (IPSEC) tunnel of an application packet session to the user terminal; an IMW-GF function (Integrated Mobile WLAN Gateway function) configured to provide an IPSEC tunnel for each application packet session with the user terminal and to match each application packet session with a packet data unit (PDU) session in a one-to-one manner; and an IMW-UE function (Integrated Mobile WLAN UE function) configured to connect to a base station of a mobile network via an air interface and to establish the PDU session with the mobile network.

### CROSS REFERENCE TO RELATED APPLICATIONS

This application is continuation of International Application No. PCT/KR2024/002569, filed on Feb. 28, 2024, and claiming priority to Korean Application No. 10-2023-0027319, filed Feb. 28, 2023, each of which is incorporated by reference herein in their entireties.

### TECHNICAL FIELD

The present invention relates to a system and a method of providing a service that can integrate mobile services and wireless local area network (LAN) services in a fifth-generation (5G) communication system.

More particularly, the present invention relates to a mobile-wireless LAN integrated system capable of supporting network slice services in a 5G system, and a method of providing the same.

### BACKGROUND

Recently, various technologies have been introduced into mobile communication systems to accommodate rapidly increasing data traffic and diverse service demands. The fifth-generation (5G) mobile communication service, which is currently being standardized, has achieved significant technical improvements such as much faster speeds and ultra-low latencies compared to the fourth-generation (4G long-term evolution (LTE)) communication systems. Based on this, the realization of mobile-based application services that were previously considered impossible, such as V2X (autonomous vehicles), drone control, and remote medical services, are becoming increasingly feasible.

In conventional fourth-generation mobile communication systems, it was impossible to guarantee differentiated conditions for specific application services because all subscribers within the network shared common network resources. However, next-generation applications targeted by 5G systems can only be operated under conditions where a certain level of performance is guaranteed. For example, the applications can be operated when conditions related to data transmission speed or network response latency are guaranteed.

In order to distinguish them from applications provided by fourth-generation mobile communication systems that share common network resources horizontally, applications requiring different network conditions are referred to as vertical applications.

For example, the fifth-generation mobile communication system adopts a virtualized network architecture to accommodate such vertical applications. Through this, the fifth-generation mobile communication system can allocate a virtual closed network, called a network slice, which satisfies high network conditions such as high resolution and high speed, to each vertical application service.

Unlike conventional mobile communication systems such as LTE, 5G applications can operate on a mobile virtual private network (mVPN) basis in the user terminal by ensuring the required performance for each application through end-to-end traffic separation and resource isolation.

Utilizing these characteristics, 5G mobile communication systems are able to provide services through network slices that guarantee specific speeds and service quality via the mobile communication network, or implement network slices such as internal Wi-Fi networks of specific organizations as secure closed networks.

However, no concrete solution exists for providing such network slice services via wireless LANs such as Wi-Fi when taking into account conditions such as speed, quality, device performance, and communication cost. Accordingly, there is a need for providing such network slice services via wireless LANs such as Wi-Fi.

For example, mobile network systems, including the 5G mobile communication system, are standardized by the 3rd Generation Partnership Project (3GPP). Such mobile communication systems are largely composed of a core network, an access network, and a terminal (e.g., a UE or user equipment).

3GPP has defined a next generation radio access network (NG-RAN) standard for the 5G access network and newly defined a wireless communication interface, through which communication between the UE and the 5G access network is carried out.

For example, FIG. 1 is a diagram illustrating the IAB (Integrated Access and Backhaul) architecture of the 3GPP standard. As shown in FIG. 1, 3GPP provides a technology that allows expansion of base stations (e.g., a BS or gNodeB (gNB)) in areas where it is difficult to install a wired backhaul, through an IAB (Integrated Access and Backhaul). In this case, the IAB-donor gNB provides a wireless backhaul to the IAB-Node via a 5G access network interface. The IAB-Node performs a function of delivering a functional split (F1) interface between a Centralized Unit (CU) and a Distributed Unit (DU) via the IAB-UE.

Although UEs connecting to the IAB-Node interact with the 5G system through the same procedure as connecting directly to a gNB, IAB only supports 5G communications in the access network based on 3GPP standards, and does not support non-3GPP access networks. Therefore, it cannot be used for integrated services with wireless LANs.

That is, 3GPP provides a method in which a base station can offer backhaul functionality to another base station through the IAB technology, but it does not consider non-3GPP access networks such as wireless LANs.

In an embodiment, FIG. 2 is a diagram illustrating an access network architecture for non-3GPP interworking. 3GPP also defines non-3GPP access networks such as Wireless LAN (WLAN), which can operate in conjunction with 5G systems. WLAN systems, commonly referred to as Wi-Fi, have separate wireless communication interfaces defined by standards such as those developed by the Institute of Electrical and Electronics Engineers (IEEE). In 5G, non-3GPP access allows the terminal (e.g., the UE) to interwork with the 5G system through Wi-Fi, and particularly when a trusted non-3GPP access network is used, the User Plane (e.g., user data transfer section) is controlled from the terminal to the 5G user plane function (UPF).

Referring to FIG. 2, 3GPP may provide a system for supporting non-3GPP access networks, such as N3IWF (Non-3GPP InterWorking Function) 40 and TNGF (Trusted Non-3GPP Gateway Function) 30.

In this case, the UE 10 can process 5G system control signals (e.g., N1 interface signals, where the N1 interface is a control plane interface between the UE 10 and an access mobility management function (AMF) 60 in the 5G core network), thereby enabling the UE 10 to perform substantially all UE 10 functions as if directly connected to a 5G access network.

For example, in a Trusted Non-3GPP network (TNAN), TNAP (Trusted Non-3GPP access point (AP) Function) 20 and TNGF 30 are used, and in an Untrusted Non-3GPP network (UTNAN), N3IWF 40 is used to provide an internet protocol security (IPSEC) tunnel with the UE 10, thereby enabling the transmission of packet data unit (PDU) sessions in the User Plane.

However, both TNGF 30 and N3IWF 40 are connected to AMF 60 and user plane function UPF 70 via standard N2/N3 interfaces, and since these networks are part of the wired network of the closed 5G core network, their support range is extremely limited. In an embodiment, the N2 interface is a control plane interface between the access network and the 5G core while the N3 interface is a user plane interface that carries data packets between the radio access network and the UPF 70.

That is, the WLAN AP in the non-3GPP access network structure is assumed to have a wired backhaul network, and particularly, the 5G NG-RAN does not provide a method for being used as the backhaul of the WLAN AP. In the existing 3GPP structure and system, using the 5G NG-RAN as a wireless backhaul for the WLAN AP causes disconnection between the WLAN system and the 5G system, making it impossible to manage the entire section between the WLAN terminal and the 5G core network. In particular, key 5G services such as network slicing, in which network resources are separated by slice based on PDU sessions from the UE to the UPF, cannot be provided.

Therefore, there is a need for a mobile-wireless LAN integrated system in which a WLAN can operate as a Trusted Non-3GPP access network.

The technical problem to be solved by the present invention is to provide a system and method that, when a 5G system is provided as a backhaul for a WLAN AP, allows the WLAN AP to operate as a Trusted Non-3GPP access network, so that a terminal (UE) connected via the WLAN can interwork with the 5G system and operate communication functions in an end-to-end controlled environment, such as in network slicing.

The technical problem to be solved by the present invention is not limited to the problems described above, and other technical problems not mentioned herein will be clearly understood by those skilled in the art from the following description.

### SUMMARY

To solve the above technical problem, according to an aspect of the present disclosure, a mobile-wireless LAN integrated system includes: an IMW-AP function (Integrated Mobile WLAN AP function) configured to perform wireless LAN-based access with a user terminal and deliver an IPSEC tunnel of an application packet session to the user terminal; an IMW-GF function (Integrated Mobile WLAN Gateway function) configured to provide an IPSEC tunnel for each application packet session with the user terminal and to match each application packet session with a PDU session in a one-to-one manner; and an IMW-UE function (Integrated Mobile WLAN UE function) configured to connect to a base station of a mobile network via an air interface and to establish the PDU session with the mobile network.

In an embodiment, the application packet session is established by a network slice dedicated application of the user terminal, and the PDU session is a PDU session for providing a network slice service. The IMW-GF function may match the application packet session with the PDU session based on a network slice service identifier.

In an embodiment, the IMW-UE function may establish the PDU session with a User Plane Function (UPF) via an N3 interface.

In an embodiment, by matching the application packet session having the IPSEC tunnel with the PDU session, network slicing may be implemented in the user terminal.

In an embodiment, the IMW-UE function is further to perform a mutual authentication process between the user terminal and a network and request the PDU session setup by specifying service characteristics.

In an embodiment, the mobile wireless LAN integrated system is further to establish a connection with the user terminal according to a wireless local area network communication standard.

An aspect of the present disclosure provides for a method of providing a mobile-wireless LAN integrated service to a user terminal using a mobile-wireless LAN integrated system according to an embodiment of the present invention. The method includes: establishing an application packet session related to an application service of the user terminal; establishing an IPSEC tunnel for the established application packet session and delivering the IPSEC tunnel to the user terminal; connecting to a mobile network according to a mobile communication standard and establishing a PDU session with the mobile network; and mutually matching the established PDU session and the application packet session with the established IPSEC tunnel in a one-to-one manner.

In an embodiment, the application packet session is established by a network slice dedicated application of the user terminal, and the PDU session is a PDU session for a network slice service. The IMW-GF function may match the application packet session and the PDU session based on a network slice service identifier.

In an embodiment, the PDU session is established with a User Plane Function (UPF) via an N3 interface.

In an embodiment, the method further includes providing a network slice service to the user terminal by matching the session with the established IPSEC tunnel and the PDU session.

In an embodiment, the method further includes performing a mutual authentication process between the user terminal and a network and requesting the PDU session setup by specifying service characteristics.

In an embodiment, the method further includes establishing a connection with the user terminal according to a wireless local area network communication standard.

According to an embodiment of the present invention, the 5G system is provided as a backhaul for a wireless LAN AP having a different standard specification, thereby enabling the provision of a 5G network slice service to a terminal via a wireless LAN, regardless of whether the environment is wired or wireless.

The advantageous effects of the present invention are not limited to those described above, and should be understood to include all effects that can be inferred from the configurations of the invention disclosed in the detailed description or the claims.

The mobile-wireless LAN integrated system supporting network slice services and the method of providing the same according to the embodiment of the present invention can enable a 5G system to be provided as a backhaul for wireless LAN APs with different standard specifications. That is, it is possible to provide 5G network slice services to terminals through wireless LANs, regardless of whether the environment is wired or wireless.

### BRIEF DESCRIPTION OF THE DRAWINGS

FIG. 1 is a diagram illustrating the IAB architecture of the 3GPP standard.

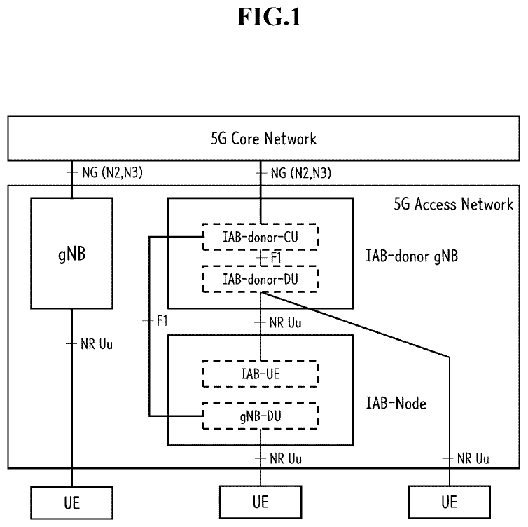

FIG. 2 is a diagram illustrating the architecture of an access network for Non-3GPP interworking.

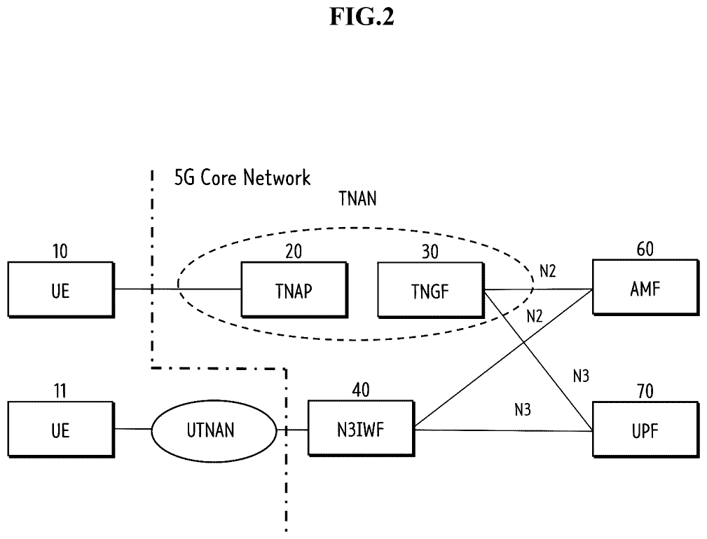

FIG. 3 is a diagram illustrating a mobile-wireless LAN integrated system according to an embodiment of the present invention.

FIG. 4 is a block diagram illustrating a detailed configuration of the mobile-wireless LAN integrated system according to an embodiment of the present invention.

FIG. 5 is a flowchart illustrating a method of providing a mobile-wireless LAN integrated service according to an embodiment of the present invention.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

Hereinafter, the present invention will be described with reference to the accompanying drawings. However, the present invention may be implemented in various different forms and is not limited to the embodiments described herein. In order to clearly describe the present invention in the drawings, parts not related to the description are omitted, and similar reference numerals are assigned to similar elements throughout the entire specification.

In the entire specification, when a part is described as being “connected” (attached, contacted, coupled) to another part, it includes not only being “directly connected” but also “indirectly connected” through another component. Also, when a part is described as “including” a component, it means that it may further include other components, unless otherwise specified.

The terminology used in this specification is intended only to describe specific embodiments and is not intended to limit the present invention. The singular expressions may include plural expressions unless the context clearly indicates otherwise. In this specification, terms such as “comprise” or “have” are intended to indicate the presence of the stated features, numbers, steps, operations, elements, components, or combinations thereof, and are not intended to exclude the possibility of the presence or addition of one or more other features, numbers, steps, operations, components, or combinations thereof.

In this specification, the term “module” includes a unit configured in hardware, software, or firmware, and may be used interchangeably with terms such as logic, logic block, component, circuit, or circuitry. A module may be an integrated component or the smallest unit performing one or more functions, or a part thereof. For example, the module may be implemented as an application-specific integrated circuit (ASIC).

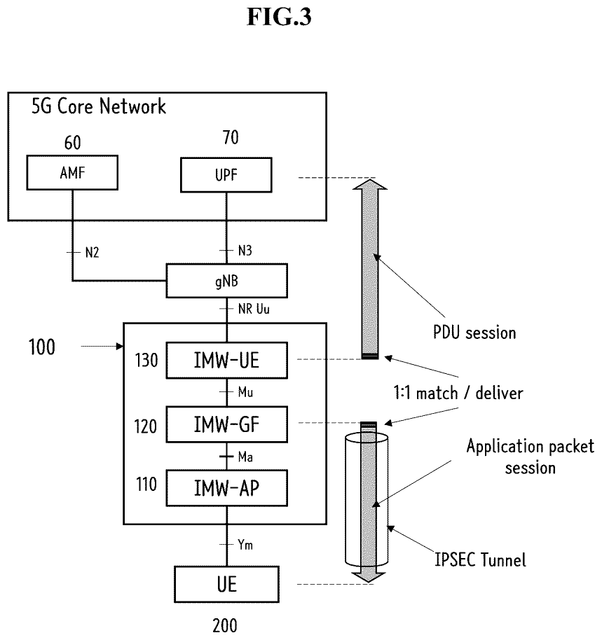

FIG. 3 is a diagram illustrating a mobile-wireless LAN integrated system according to an embodiment of the present invention.

A user terminal (e.g., a user equipment (UE)) 200 connects to a mobile-WLAN integrated system 100 via a WLAN method, and the system 100 can wirelessly connect to a base station (gNB) of a 5G access network via the air interface—e.g., via the NR-Uu interface.

The mobile-wireless LAN integrated system 100 establishes a PDU session with the UPF 70 of the 5G core network and performs the function of matching it one-to-one with the application packet session of the user terminal 200. According to an embodiment of the present invention, the mobile-wireless LAN integrated system 100 includes an Integrated Mobile WLAN Access Point (IMW-AP) function unit 110, an Integrated Mobile WLAN Access Point (IMW-GF) function unit 120, and an Integrated Mobile WLAN User Equipment (IMW-UE) function unit 130.

In an embodiment, the IMW-AP function unit 110 performs functions similar to the function of an access point (AP). For example, the IMW-AP function unit 110 connects to the user terminal 200 according to the WLAN access method and delivers the IPSEC tunnel of the application packet session. Specifically, the interface (Ym) between the user terminal 200 and the IMW-AP function unit 110 is provided at the physical layer through a WLAN standard, and functions to deliver the IPSEC tunnel between the IMW-GF function unit 120 and the user terminal 200 at the upper protocol layer.

The IMW-GF function unit 120 provides an IPSEC tunnel for each application packet session with the user terminal 200, and delivers all application packets established through the IPSEC tunnel. The interface (Ma) between the IMW-GF function unit 120 and the IMW-AP function unit 110 is a wired interface for internal communication within the system 100. The IMW-GF function unit 120 also performs a gateway function by matching one-to-one between the application packet session and the PDU session created by the IMW-UE function unit 130.

The IMW-UE function unit 130 performs wireless communication with a base station (gNB) via the NR-Uu interface as described above. To this end, the IMW-UE function unit 130 performs terminal functions compliant with 3GPP standards. Meanwhile, the IMW-UE function unit 130 and the IMW-GF function unit 120 exchange information via the Mu interface for establishing, terminating, and managing the PDU session. The PDU session established between the IMW-UE function unit 130 and the UPF 70 is matched one-to-one and exchanged with the application packet session established between the IMW-GF function unit 120 and the user terminal 200.

Here, the Access and Mobility Function (AMF) 60 supports mobility using subscriber authentication data, and the User Plane Function (UPF) 70 delivers packets transmitted from the user terminal 200 to a data network (DN) (e.g., not illustrated). The N2 and N3 interfaces are the same as those defined in the 3GPP standard document TS 23.501. That is, the N2 interface is a control plane interface between the access network and the 5G core network and the N3 interface is a user plane interface that carries data packets between the RAN and the UPF 70.

The mobile-wireless LAN integrated system 100 may separately configure resources for processing each one-to-one matched pair of a PDU session and an application packet session. Accordingly, network slicing between the 5G core network and the user terminal 200 can be implemented in a manner similar to 5G system network slicing.

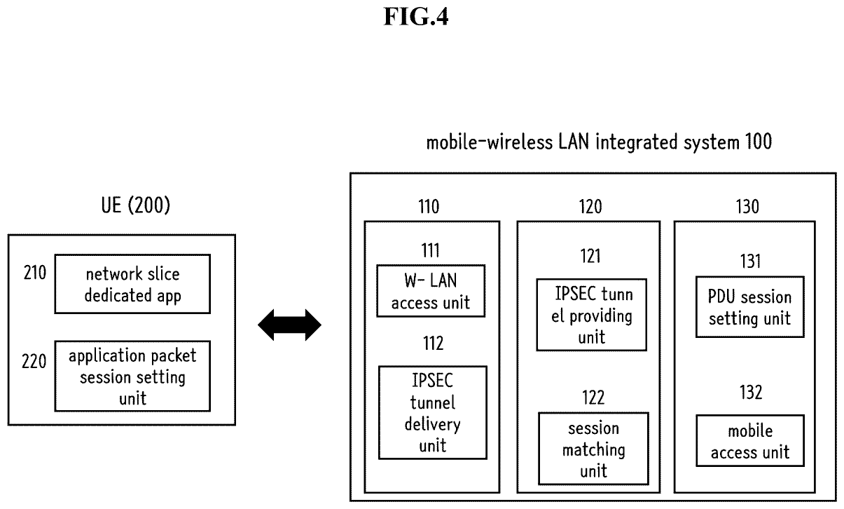

FIG. 4 is a block diagram illustrating a detailed configuration of the mobile-wireless LAN integrated system 100 and the user terminal 200 according to an embodiment of the present invention.

In order to use the network slice dedicated app, the user terminal 200 may include a network slice dedicated application (app) 210 and an application packet session setting unit 220.

The network slice dedicated app 210 includes content, application programming interfaces (APIs), or agents for using the network slice service, and supports use of the network slice service when a PDU session is established with the network slice service system.

The application packet session setting unit 220 establishes a session for the application packet used by the user terminal 200. For example, the application packet session may be configured for the network slice service and may be associated with an identifier for identifying the network slice.

The IMW-AP function unit 110 may include a WLAN access unit 111 and an IPSEC tunnel delivery unit 112.

The WLAN access unit 111 may be implemented as a WLAN modem and may be implemented with any device or module that conforms to the IEEE 802.11 standard. The WLAN access unit 111 may perform functions such as digital-to-radio signal conversion with the user terminal 200, network generation, security, and Internet sharing.

The IPSEC tunnel delivery unit 112 performs the function of delivering the IPSEC tunnel generated by the IMW-GF function unit 120 for the application packet session to the user terminal 200. In an embodiment, the IPSEC tunnel is a type of protocol used to securely transmit data over a network by creating a secure virtual communication tunnel between two points located in different network positions, ensuring confidentiality, integrity, and authentication of the data.

The IMW-GF function unit 120 may include an IPSEC tunnel providing unit 121 and a session matching unit 122.

In an embodiment, the IPSEC tunnel providing unit 121 configures the above-described IPSEC tunnel for a specific application packet session to provide confidentiality, integrity, and authentication of data.

The session matching unit 122 performs one-to-one matching between each application packet session with an IPSEC tunnel and each PDU session. Through this, the user terminal 200 can establish a PDU session for a specific network slice service via a WLAN.

In an embodiment, the application packet session and the PDU session may be matched based on a network slice service identifier.

The IMW-UE function unit 130 may include a PDU session setting unit 131 and a mobile access unit 132.

The PDU session setting unit 131 performs a mutual authentication process between the user terminal 200 or the mobile WLAN integrated system 100 and the 5G core network and requests a PDU session setup by specifying required service characteristics. During or after the mutual authentication process, the mobile WLAN integrated system 100 may be registered as a network identity as a system that integrates mobile and WLAN. The service may be a network slice service, and the PDU session may be established through appropriate configuration and resource allocation.

The mobile access unit 132 transmits and receives control signals and data signals with a base station (gNB) according to the frequency band, modulation scheme, and session management defined by the NR-Uu interface.

According to the configuration described above, the application packet session established with an IPSEC tunnel by the network slice dedicated app of the user terminal 200 is matched one-to-one with a PDU session. Therefore, the user can use a network slicing service in a manner similar to the 5G system's network slice service even in an end-to-end controlled environment.

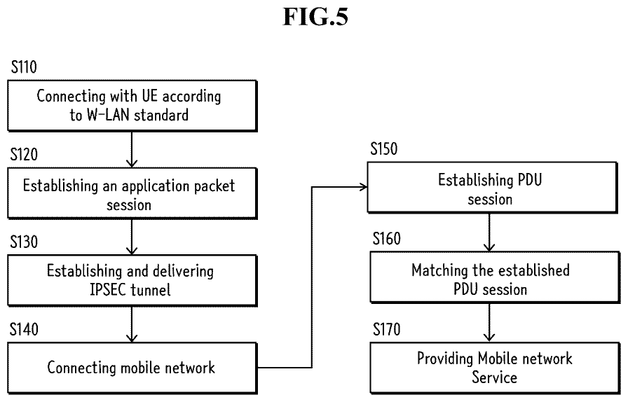

FIG. 5 is a flowchart illustrating a method of providing a mobile-wireless LAN integrated service according to an embodiment of the present invention. Although one or more steps are described or shown in particular sequential order, in other embodiments the operations may be rearranged in a different order, which may include performance of multiple operations in at least partially overlapping time periods. In an embodiment, the method 400 is performed by a user terminal 200 and WLAN integrated system 100.

In step (S110), a connection with the user terminal (UE) is performed according to a WLAN communication standard. The WLAN communication may be performed by any device or module that conforms to the IEEE 802.11 standard. During step S110, functions such as digital-to-radio signal conversion, network creation, security, and internet sharing supported by the WLAN AP or modem may also be supported.

In step (S120), an application packet session related to an application service of the user terminal is established. The application service may be a network slice service, and an identifier for identifying the network slice may be associated with the application packet session.

In step (S130), an IPSEC tunnel is established for the application packet session and delivered to the user terminal for data transmission and reception. The IPSEC tunnel is a type of protocol for securely transmitting data over a network, creating a secure virtual communication tunnel between two points in different network locations, and ensuring the confidentiality, integrity, and authentication of the data.

In step (S140), a connection is made to the mobile network according to mobile communication standards. For example, control signals and data signals may be transmitted and received with a base station (gNB) according to the frequency band, modulation scheme, and session management defined in the NR-Uu interface of the 5G access network.

In step (S150), a PDU session is established with the mobile network. For example, a mutual authentication process is performed with the 5G core network and a request is made to establish a PDU session by specifying the required service characteristics.

In step (S160), the established PDU session is matched with the application packet session for which the IPSEC tunnel has been established. Therefore, the user can utilize a network slicing service in a manner similar to the 5G system's network slice service even in an end-to-end controlled environment.

As such, when the PDU session and the application packet session with the established IPSEC tunnel are matched with each other, in step (S170), the user terminal can receive a mobile-dedicated network slice service via a WLAN using the matched PDU session and application packet session.

The method according to the above-described embodiment of the present invention may be implemented as program instructions that can be executed by various computer components and recorded on a computer-readable recording medium. The computer-readable recording medium may include program instructions, data files, and data structures either alone or in combination. The program instructions recorded on the computer-readable recording medium may be specially designed and configured for the embodiments of the present invention or may be known and available to those skilled in the field of computer software. The computer-readable recording medium includes magnetic storage media such as hard disks, floppy disks, and magnetic tapes, optical storage media such as CD-ROMs and DVDs, magneto-optical storage media such as floptical disks, and hardware configured to store and execute program instructions such as ROM, RAM, and flash memory. The program instructions include machine code generated by a compiler as well as high-level language code that can be executed by a computer using an interpreter. The hardware may be configured to operate as one or more software modules to process the method according to the present invention, and vice versa.

The method according to an embodiment of the present invention may be executed in the form of program instructions on an electronic device. The electronic device includes portable communication devices such as smartphones or smart pads, computer devices, portable multimedia devices, portable medical devices, cameras, wearable devices, and home appliances.

The method according to an embodiment of the present invention may be provided as a computer program product. The computer program product may be traded as a commodity between a seller and a buyer. The computer program product may be distributed in the form of a machine-readable recording medium or online through an application store. In the case of online distribution, at least part of the computer program product may be temporarily stored or generated on a storage medium such as a manufacturer's server, an application store server, or an intermediate server.

Each component according to the embodiment of the present invention, such as a module or a program, may consist of one or more subcomponents, and some subcomponents may be omitted or additional subcomponents may be included. Some components (modules or programs) may be integrated into a single entity and may perform functions equivalent or similar to those of the respective components prior to integration. The operations performed by the modules, programs, or other components according to the embodiment of the present invention may be performed sequentially, in parallel, repeatedly, heuristically, or in different orders, with some operations being omitted or additional operations being added.

The above description of the present invention is intended as an example, and those skilled in the art to which the present invention pertains will understand that various other specific forms can be easily modified without changing the technical spirit or essential characteristics of the present invention. Therefore, the above-described embodiments should be understood as illustrative in all respects and not restrictive. For example, each component described as a single type may be implemented in a distributed manner, and likewise, components described as distributed may be implemented in a combined form.

The scope of the present invention is defined by the claims that follow, and all modifications or variations derived from the meaning, scope, and equivalent concepts of the claims shall be interpreted as being included within the scope of the present invention.

1. A mobile-wireless local access network (WLAN) integrated system comprising:
an Integrated Mobile WLAN Access Point (AP) (IMW-AP) function configured to perform wireless LAN-based access with a user terminal and to deliver an internet protocol security (IPSEC) tunnel of an application packet session to the user terminal;
an Integrated Mobile WLAN Gateway (IMW-GF) function configured to provide the IPSEC tunnel for each application packet session with the user terminal and to match each application packet session with a packet data unit (PDU) session in a one-to-one manner; and
an Integrated Mobile WLAN UE (IMW-UE) function configured to connect to a base station of a mobile network via an air interface and to establish the PDU session with the mobile network.

2. The mobile-wireless LAN integrated system of claim 1:
wherein the application packet session is established by a network slice dedicated application of the user terminal,
wherein the PDU session is a PDU session for a network slice service, and
wherein the IMW-GF function matches the application packet session and the PDU session based on a network slice service identifier.

3. The mobile-wireless LAN integrated system of claim 1:
wherein the PDU session is established with a User Plane Function (UPF) via an interface.

4. The mobile-wireless LAN integrated system of claim 3:
wherein network slicing is implemented in the user terminal by matching the application packet session provided with the IPSEC tunnel and the PDU session.

5. The mobile-wireless LAN integrated system of claim 1, wherein the IMW-UE function is further configured to;
perform a mutual authentication process between the user terminal and a network; and
request the PDU session setup by specifying service characteristics.

6. The mobile-wireless LAN integrated system of claim 1, wherein the mobile-wireless LAN integrated system is further configured to:
establish a connection with the user terminal according to wireless local access network communication standard.

7. A method of providing a mobile-wireless local access network (LAN) integrated service by a mobile-wireless LAN integrated system to a user terminal, comprising:
establishing an application packet session related to an application service of the user terminal;
establishing an internet protocol security (IPSEC) tunnel for the established application packet session and delivering it to the user terminal;
connecting to a mobile network according to a mobile communication standard and establishing a packet data unit (PDU) session with the mobile network; and
mutually matching the established PDU session and the application packet session with the established IPSEC tunnel in a one-to-one manner.

8. The method of claim 7:
wherein the application packet session is established by a network slice dedicated application of the user terminal,
wherein the PDU session is a PDU session for a network slice service, and
wherein an Integrated Mobile WLAN Gateway (IMW-GF) function matches the application packet session and the PDU session based on a network slice service identifier.

9. The method of claim 8:
wherein the PDU session is established with a User Plane Function (UPF) via an interface.

10. The method of claim 9, further comprising:
providing a network slice service to the user terminal by matching the application packet session with the established IPSEC tunnel and the PDU session.

11. The method of claim 6, further comprising:
performing a mutual authentication process between the user terminal and a network; and
requesting the PDU session setup by specifying service characteristics.

12. The method of claim 6, further comprising:
establishing a connection with the user terminal according to a wireless local area network communication standard.
